(19) United States
(12) Patent Application Publication
(10) Pub. No.: US 2025/0361364 A1
(43) Pub. Date: Nov. 27, 2025

(54) POLYETHER-SILOXANE BLOCK COPOLYMERS FOR PRODUCING POLYURETHANE FOAMS

(71) Applicant: EVONIK OPERATIONS GMBH, Essen (DE)

(72) Inventors: Michael FERENZ, Essen (DE); Jörg DIENDORF, Essen (DE); Sven GAHRENS, Essen (DE); Petra SCHNELL, Essen (DE); Ursula SKRZYPCZYK, Herne (DE)

(73) Assignee: EVONIK OPERATIONS GMBH, Essen (DE)

(21) Appl. No.: 18/871,899

(22) PCT Filed: Jun. 2, 2023
(86) PCT No.: PCT/EP2023/064768

§ 371 Date: Dec. 5, 2024

(30) Foreign Application Priority Data
Jun. 8, 2022 (EP) 22177758.4

(51) Int. Cl. C08G 77/46

(52) U.S. Cl. CPC C08G 77/46

(57) ABSTRACT

A process for preparing polyether-siloxane block copolymers by hydrosilylation of alpha, omega-modified hydrosiloxanes with alpha,omega-modified di(meth)allyl polyethers in the presence of a hydrosilylation catalyst, wherein the reaction is performed in a solvent mixture comprising aromatic solvents and alkoxylated alcohol, is described.

The present invention is in the field of polyethersiloxanes, polyurethanes and polyurethane foams.

It relates more particularly to the production of specific polyether-siloxane block copolymers and to specific formulations and to the use thereof for production of polyurethane foams, preferably of rigid polyurethane foam, more preferably one-component canned PU foam (building foam, assembly form, one-component foam/OCF) and other rigid polyurethane foams where a high cell content is advantageous (e.g. open-cell spray foam, packaging foam, headliner foam, pipe insulation foams, floral foam, thermoformable rigid foams etc.).

One-component canned PU foam is known per se. It is a polyurethane foam which is foamed by pressurized propellant gas from a pressurized can. Fields of use are the assembly, bonding and sealing of windows, door frames, pipes, bushings etc., and the filling of gaps in brickwork, cavities, cracks and joins. Such a foam is preferably produced by the providing of a prepolymer formed from polyol and isocyanate (preferably methylene diphenyl isocyanate, MDI) in the pressurized can, which is driven out by the propeller gas (propellant) and cured by ambient moisture. Polyol-isocyanate prepolymers have both reactive isocyanate groups and urethane bonds.

For all the abovementioned applications, it is important that the finished one-component PU foam shows a small change in geometric dimensions during and especially after the curing process. This dimensional stability, i.e. low shrinkage or low post-expansion, is achieved by a high open-cell content of the foam. At the same time, the foam, by virtue of this open-cell content, must not however have any major foam defects in the form of cavities; for this the cells of the foam should still be fine and not have any coarsening. For that reason, it is customary to add a cell opener to the polyol-isocyanate prepolymer as well as the customarily present foam stabilizer (usually a polyethersiloxane), and polyether-siloxane block copolymers in particular have been found to be particularly efficient for this application. In general, these cell openers feature a linear [AB]ₙ block structure of alternating polyether and siloxane chains. For good cell-opening efficacy, a high molecular weight is important; at the same time, the reproducible production of such molecular weights is a challenge.

Non-hydrolysable [AB]ₙ polyethersiloxanes are known to the person skilled in the art. For example, U.S. Pat. No. 3,957,842 describes such polymers. That patent describes the preparation of these structures by the hydrosilylation of diallyl polyethers with α,ω-SiH-functional siloxanes in toluene. The molecular weight of the resultant polymers is about 36 000-56 000 g/mol.

U.S. Pat. No. 4,150,048 describes non-hydrolysable [AB]ₙ polyethersiloxanes that are prepared by hydrosilylation of polyethers having two CH₂═C(R)CH₂ end groups per molecule, where R is a monovalent hydrocarbon group. They are prepared with α,ω-SiH-functional siloxanes under hydrosilylation reaction conditions in the presence of a platinum catalyst. The linear block copolymers prepared are particularly useful as surfactants and foam stabilizers for the production of polyurethane foams. The low tendency to isomerization of the CH₂═C(R)CH₂— group to give non-reactive species during the hydrosilylation reaction leads to the unexpectedly high molecular weight of the copolymers.

U.S. Pat. No. 5,869,727 describes a vacuum process for preparing siloxane-oxyalkylene copolymers.

U.S. Pat. No. 20,190,233646 describes a composition comprising [AB]ₙ polyethersiloxanes. The composition comprises a polyether-polysiloxane block copolymer and a liquid organic monool compound which is either a glycol ether compound having a degree of polymerization, a terminal hydrogen or an alcohol compound having a branched alkyl group having 12 or more carbon atoms.

As already described, a high molar mass is important and therefore particularly desirable for the provision of a high open cell content. Too low a molar mass of the cell opener would lead here to a reduced cell-opening effect, as a result of which the foam would shrink or expand further. As well as a maximum molecular weight of the cell opener, however, it is also important that the molar mass distribution is as narrow as possible. In particular, tailing of the molar mass distribution toward very high molar masses can have an adverse effect. Such tailing can make the viscosity of the cell opener very high, which greatly impairs the processibility thereof during foam production.

The problem addressed by the present invention was therefore that of providing polyether-siloxane block copolymers that feature a particularly high molecular weight coupled with simultaneously very narrow molar mass distribution and, associated with this, have particularly efficient efficacy as a cell opener.

It has been found that, surprisingly, the use of a particular solvent mixture enables the preparation of corresponding polyether-siloxane block copolymers and hence the solution of the stated problem.

The present invention therefore provides a process for preparing polyether-siloxane block copolymers of formula 1

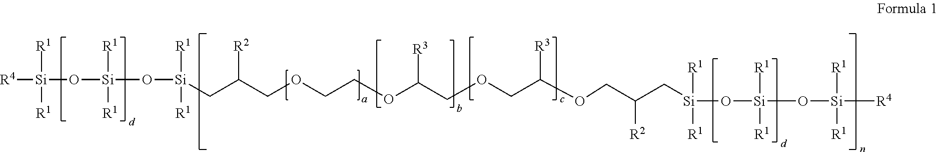

where
a=0 to 100, preferably 5 to 75, more preferably 10 to 50,
b=0 to 100, preferably 5 to 75, more preferably 5 to 25,
c=0 to 100, preferably 5 to 75, more preferably 5 to 25, a+b+c>3,
d=1 to 100, preferably 5 to 50, more preferably 7 to 40, most preferably 12 to 30,
n=5 to 200, preferably 10 to 100, more preferably 15 to 50, and
where the R¹ radicals are each independently identical or different monovalent aliphatic or aromatic hydrocarbon radicals having 1 to 20 carbon atoms, preferably having 1 to 10 carbon atoms, especially preferably methyl radicals, and
where the R² radicals are independently identical or different monovalent aliphatic, saturated or unsaturated hydrocarbon radicals having 1 to 20 carbon atoms or OH, preference being given especially to methyl radicals, and
where the R³ radicals are independently identical or different monovalent aliphatic or aromatic hydrocarbon radicals having 1 to 20 carbon atoms, preferably methyl radicals, and
where the R⁴ radicals are independently selected from one of the R⁵, R⁶, R⁷ radicals and H, where the R⁵ radicals conform to the formula 2

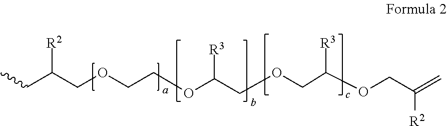

and where the R⁶ radicals conform to the formula 3

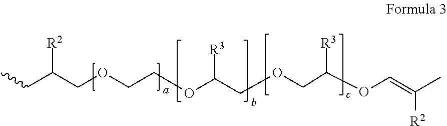

and where the R⁷ radicals conform to the formula 4

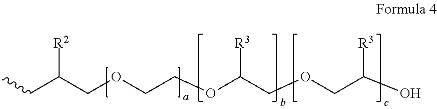

where the indices a, b and c and the R² and R³ radicals are as defined above, by hydrosilylation of alpha, omega-modified hydrosiloxanes with alpha, omega-modified di(meth)allyl polyethers in the presence of a hydrosilylation catalyst capable of catalysing the formation of an SiC bond by addition of an Si—H group onto a (meth)allylic double bond,
wherein the reaction is conducted in a solvent mixture comprising at least one aromatic solvent of the general formula 5

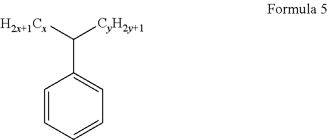

where
x=0-20, preferably 0-16,
y=0-20, preferably 0-16,
x+y=6-20, preferably 8-16,
and at least one alkoxylated alcohol of the formula 6

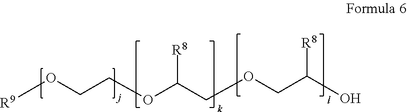

where
j=0 to 30, preferably 0 to 10, more preferably 0,
k=0 to 20, preferably 0 to 10, more preferably 0 to 5,
l=1 to 20, preferably 2 to 10, more preferably 3 to 5, and
where the R⁹ radical is a monovalent aliphatic saturated or unsaturated, linear or branched hydrocarbon radical having 6-40, preferably having 8-30, even more preferably having 10-22, carbon atoms, and
where the R⁸ radicals are independently identical or different monovalent aliphatic or aromatic hydrocarbon radicals having 1 to 20 carbon atoms, preferably methyl radicals.

The sequence of the different oxyalkylene units that are specified between square brackets and with small-letter indices in the polyoxyalkylene radicals, polyols or alkoxylated alcohols may be random (statistically distributed), blockwise, gradually varying, or any mixture of these options in sections. The structural formulae specified here are merely a simplified graphical illustration in relation to the sequence.

The solvent mixture according to the invention thus comprises at least two components: aromatic solvent of the formula 5 and alkoxylated alcohol of the formula 6; it preferably consists of these two components.

In a very particularly preferred embodiment of the invention, the solvent mixture according to the invention does not contain any polyether of the formula 8

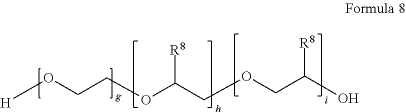

where
g=0 to 75, preferably 0 to 50, more preferably 0 to 25,
h=1 to 100, preferably 2 to 50, more preferably 3 to 25,
i=1 to 100, preferably 2 to 50, more preferably 3 to 25, and
where the R⁸ radicals are independently identical or different monovalent aliphatic or aromatic hydrocarbon radicals having 1 to 20 carbon atoms, preferably methyl radicals.

Such a solvent mixture of the invention which thus comprises at least aromatic solvent of the formula 5 and alkoxylated alcohols of the formula 6, but which is free of polyether of the formula 8, is a very particularly preferred embodiment of the invention.

The advantages of the process according to the invention are not only that it enables the provision of corresponding polyether-siloxane block copolymers having high molecular weight and simultaneously very narrow molar mass distribution, but also that the resulting formulations, with a comparatively high active ingredient content, have a comparatively low viscosity, and hence have considerable processing advantages.

A further advantage is that the resulting polyether-siloxane block copolymers, with high molecular weight, have a narrow molar mass distribution. It is thus especially possible to assure the provision of polyether-siloxane block copolymers of formula 1 having a weight-average molecular weight Mw (g/mol) of ≥60 000, advantageously >80 000, preferably >90 000, especially >100 000, where M_{w}/Mₙ<4.5, preferably <4.0, especially <3.5. Mₙ is the number-average molar mass.

The high molar mass is especially advantageous in this context for the inventive use of the polyether-siloxane block copolymers described as cell openers for production of polyurethane foams, preferably of rigid polyurethane foams (especially one-component canned PU foams, open-cell spray foam, packaging foam, headliner foam, pipe insulation foams, floral foam, thermoformable rigid foams etc.), because these can be used to produce particularly open-cell foams. As well as the open-cell content, a regular foam and pore structure and a low foam defect rate are achieved. The low viscosity and narrow molar mass distribution are likewise valuable from this point of view.

Polyether-siloxane block copolymers are known per se. In the context of the entire present invention, the term “polyether” encompasses polyoxyalkylenes, preference being given particularly to polyoxyethylene and polyoxypropylene and also to polyoxyethylene-polyoxypropylene copolyethers. The distribution of various oxyalkylene units along the polymer backbone may be different. Mixed polyethers can be constructed, for example, statistically, in blocks or with different gradients of the monomer units to each other. Statistical construction in this context signifies that the polyoxyethylene and polyoxypropylene units are distributed in a random sequence across the polyether chain, whereas a blockwise constructed polyether consists of defined polyoxyethylene and polyoxypropylene blocks.

In the context of the entire present invention, the term siloxane includes compounds from the class of polyorganosiloxanes, the class of polydimethylsiloxanes being especially preferred. In the context of the entire present invention, the term polyether-siloxane block copolymers includes polymers which are constructed from alternating polyether and siloxane blocks. The polyether-siloxane block copolymers of the invention are subject to the formula 1.

The term polyurethane foam is known per se to those skilled in the art (see, for example, Adam et al., “Polyurethanes”, Ullmann's Encyclopedia of Industrial Chemistry—Paragraph 7″, 2012, Wiley VCH-Verlag, Weinheim).

A preferred inventive composition of a PU foam, preferably rigid polyurethane foam, contains the following constituents:
a) inventive polyether-siloxane block copolymer as cell opener
b) polyol component
c) (poly) isocyanate component
d) catalyst
e) optionally foam stabilizer
f) blowing agent
g) optionally further additives, preferably fillers, liquid flame retardants, etc.

The terms “polyurethane” and “polyurethane foam” are established technical terms which have long been known to those skilled in the art.

Polyurethane (PU) in the context of the present invention is especially understood to mean a product obtainable by reaction of a polyisocyanate component with a polyol component.

In addition to the polyurethane, further functional groups may also be formed in the reaction, for example uretdiones, carbodiimides, isocyanurates, allophanates, biurets, ureas and/or uretonimines.

For the purposes of the present invention, therefore, PU is understood as meaning not just polyurethane, but also polyisocyanurates, polyureas, and polyisocyanate reaction products containing uretdione, carbodiimide, allophanate, biuret and/or uretonimine groups.

Accordingly, polyurethane foam (PU foam) in the context of the present invention is understood to mean a foam which is obtained as a reaction product of a polyisocyanate component and a polyol component. In addition to the eponymous polyurethane, further functional groups may be formed here as well, examples being allophanates, biurets, ureas, carbodiimides, uretdiones, isocyanurates or uretonimines.

Rigid PU foam is an established technical term. The known and fundamental difference between flexible foam and rigid foam is that flexible foam shows elastic characteristics and hence deformation is reversible. By contrast, rigid foam is permanently deformed. Further details regarding rigid polyurethane foams can also be found in “Kunststoffhandbuch, Band 7, Polyurethane [Plastics Handbook, volume 7, Polyurethanes]”, Carl Hanser Verlag, 3rd Edition 1993, Chapter 6. Particularly preferred PU foams in the context of the present invention are rigid polyurethane foams, one-component canned foam, open-cell spray foam, packaging foam, headliner foam, pipe insulation foam, floral foam, thermoformable rigid foam and/or further rigid polyurethane foams where a high open-cell content is advantageous.

Polyol components (b) used may be one or more organic compounds comprising OH groups, SH groups, NH groups and/or NH2 groups and having a functionality of 1.8 to 8. The polyol component comprises at least one compound having at least two isocyanate-reactive groups selected from OH groups, SH groups, NH groups and/or NH2 groups, especially OH groups.

A functionality of 1.8, for example, may arise as a result of at least one compound having a relatively high functionality, for example of greater than or equal to 2, being mixed with at least one compound having a functionality of, for example, 1. This may occur in particular when a polyisocyanate component (c) having a functionality of greater than 2 or additional crosslinkers are used as optional additives (h).

Appropriate compounds which may typically be used when producing PU foams are known to those skilled in the art and for example described in “Kunststoffhandbuch, Band 7, Polyurethane [Plastics Handbook, volume 7, Polyurethanes]”, Carl Hanser Verlag, 3rd Edition 1993, Chapter 3.1. It is customary to use compounds having OH numbers within a range from 10 to 1200 mg KOH/g.

Particularly preferred compounds are all polyether polyols and polyester polyols typically used for production of polyurethane systems, especially polyurethane foams.

In addition, it is possible to use polyether polycarbonate polyols, polyols based on natural oils (natural oil based polyols, NOPs; described in WO 2005/033167, US 2006/0293400, WO 2006/094227, WO 2004/096882, US 2002/0103091, WO 2006/116456, EP 1678232), filled polyols, prepolymer-based polyols and/or recycled polyols.

Recycled polyols are polyols that are obtained from the chemical recycling of polyurethanes, for example by solvolysis, for example glycolysis, hydrolysis, acidolysis or aminolysis. The use of recycled polyols constitutes a particularly preferred embodiment of the invention.

When the polyol component contains polyol-isocyanate prepolymers, this is a preferred embodiment of the invention.

Isocyanate or polyisocyanate components (c) used may generally be one or more polyisocyanates having two or more isocyanate groups. Suitable polyisocyanates for the purpose of the present invention are all organic isocyanates having two or more isocyanate groups, in particular the aliphatic, cycloaliphatic, arylaliphatic and preferably aromatic polyfunctional isocyanates known per se.

Examples that may be mentioned here are alkylene diisocyanates having 4 to 12 carbon atoms in the alkylene radical, for example dodecane 1,12-diisocyanate, 2-ethyltetramethylene 1,4-diisocyanate, 2-methylpentamethylene 1,5-diisocyanate, tetramethylene 1,4-diisocyanate, pentamethylene diisocyanate (PDI) and preferably hexamethylene 1,6-diisocyanate (HMDI), cycloaliphatic diisocyanates such as cyclohexane 1,3-and 1,4-diisocyanate and the corresponding isomer mixtures, methylene dicyclohexyl 4,4′-diisocyanate (H12MDI), isophorone diisocyanate (IPDI), methylcyclohexyl 2,4-and 2,6-diisocyanate and the corresponding isomer mixtures, and preferably aromatic diisocyanates and polyisocyanates such as toluene 2,4-and 2,6-diisocyanate (TDI) and the corresponding isomer mixtures, naphthalene diisocyanate, diethyltoluene diisocyanate, diphenylmethane 4,4′- or 2,2′- or 2,4′-diisocyanate (MDI) and polymethylene polyphenyl polyisocyanate (PMDI, “polymeric MDI”). The organic polyisocyanates may be used individually or in the form of mixtures thereof. It is likewise possible to use corresponding “oligomers” of the diisocyanates, such as the IPDI trimer based on the isocyanurate, biurets or uretdiones. Furthermore, the use of prepolymers based on the abovementioned isocyanates is possible. The mixture of MDI and more highly condensed analogues having an average functionality of 2 to 4 which is known as polymeric MDI (also referred to as “crude MDI”) is particularly suitable, as well as the various isomers of TDI in pure form or as isomeric mixture. It is also possible to use isocyanates which have been modified by the incorporation of urethane, uretdione, isocyanurate, allophanate and other groups, known as modified isocyanates. Examples of particularly suitable isocyanates are also detailed for example in EP 1712578, EP 1161474, WO 00/58383, US 2007/0072951, EP 1678232 and WO 2005/085310, which are hereby fully incorporated by reference.

A preferred ratio of polyisocyanate component and polyol component, expressed as the index of the formulation, i.e. as stoichiometric ratio of isocyanate groups to isocyanate-reactive groups (e.g. OH groups, NH groups) multiplied by 100, is in the range from 10 to 1000 and preferably from 40 to 500. An index of 100 represents a molar ratio of reactive groups of 1:1.

Suitable catalysts (d) which are usable for the production of polyurethanes, in particular PU foams, are known to those skilled in the art from the prior art. Usable compounds in the context of present invention are all compounds capable of catalysing the reaction of isocyanate groups with OH groups, NH groups or other isocyanate-reactive groups, and/or the reaction of isocyanate groups with one another.

It is possible to employ here the customary catalysts known from the prior art, including for example amines (cyclic, acyclic; monoamines, diamines, oligomers having one or more amino groups), ammonium compounds, metal-organic compounds and/or metal salts, preferably those of tin, iron, bismuth, potassium and/or zinc. In particular, catalysts used may be mixtures of two or more compounds of this kind.

Foam stabilizers (e) and the use thereof in the production of PU foams are known to those skilled in the art. The use of foam stabilizers is optional; preference is given to using one or more foam stabilizers. Foam stabilizers that may be used are in particular surface-active compounds (surfactants). Preference is given to using foam stabilizers. They may be used to optimize the desired cell structure and the foaming process. In the context of the present invention, it is possible in particular to use Si-containing compounds that assist foam production (stabilization, cell regulation, cell opening, etc.). These compounds are sufficiently well known from the prior art. Particular preference is given to using at least one foam stabilizer based on a polyether siloxane. Corresponding siloxane structures which are usable in the context of this invention are described, for example, in the following patent documents, although these describe use only in conventional PU foams (e.g. as moulded foam, mattress, insulation material, construction foam, etc.): CN 103665385, CN 103657518, CN 103055759, CN 103044687, US 2008/0125503, US 2015/0057384, EP 1520870 A1, EP 1211279, EP 0867464, EP 0867465, EP 0275563. As well as surface-active Si-containing compounds, Si-free surfactants may also be used. For example, EP2295485 A1 describes the use of lecithin and U.S. Pat. No. 3,746,663 the use of vinylpyrrolidone-based structures as foam stabilizer for the production of rigid PU foam. Further Si-free foam stabilizers are described for example in EP 2511328 B1, DE 1020011007479 A1, DE 3724716 C1, EP 0734404, EP 1985642, DE 2244350 and U.S. Pat. No. 5,236,961.

Blowing agents and the use thereof in the production of PU foams are known to those skilled in the art. The use of blowing agents is optional; preference is given to using blowing agents. The use of a blowing agent (f) or of a combination of two or more blowing agents (f) depends in principle on the nature of the foaming process used, on the nature of the system and on the use for the PU foam obtained. Chemical and/or physical blowing agents may be used, as well as a combination of the two. Depending on the amount of blowing agent used, a foam having high or low density is produced. For instance, foams can be produced having densities of 5 kg/m³ to 900 kg/m³, preferably 5 to 350 kg/m³, particularly preferably 8 to 200 kg/m³, especially 8 to 150 kg/m³.

Physical blowing agents that may be used are one or more of the appropriate compounds having suitable boiling points and mixtures thereof, for example hydrocarbons having 3, 4 or 5 carbon atoms, preferably cyclo-, iso-, n-pentane, hydrofluorocarbons (HFCs), preferably HFC 245fa, HFC 134a or HFC 365mfc, hydrochlorofluorocarbons (HCFCs), preferably HCFC 141b, hydrofluoroolefins (HFOs) or hydrohaloolefins, preferably 1234ze, 1234yf, 1224 yd, 1233zd (E) or 1336mzz, esters, preferably methyl formate, ketones, preferably acetone, ethers, preferably dimethoxymethane, or chlorinated hydrocarbons, preferably dichloromethane or 1,2-dichloroethane.

It is likewise also possible to use gaseous blowing agents in pressurized cans, useful examples of which include all gases suitable for the purpose under pressure or in pressure-liquefied form, for example hydrocarbons such as butane isomers and propane isomers, dimethyl ether, nitrogen, air and other suitable gases.

Chemical blowing agents used may be one or more compounds that react with NCO groups with the release of gases, for example water or formic acid, or which release gases during the reaction as a result of the rise in temperature, for example sodium hydrogencarbonate.

Optional additives (h) used may be one or more of the substances which are known from the prior art and are used in the production of polyurethanes, especially PU foams, for example crosslinkers, chain extenders, stabilizers against oxidative degradation (known as antioxidants), flame retardants, biocides, cell-refining additives, nucleating agents, further cell openers, solid fillers, antistatic additives, thickeners, dyes, pigments, colour pastes, fragrances, and/or emulsifiers etc.

As optional flame retardant, the composition according to the invention may contain one or more of the known flame retardants suitable for production of PU foams, for example halogen-containing or halogen-free organic phosphorus-containing compounds, for example triethyl phosphate (TEP), tris(1-chloro-2-propyl) phosphate (TCPP), tris(2-chloroethyl) phosphate (TCEP), dimethyl methanephosphonate (DMMP), dimethyl propanephosphonate (DMPP), ammonium polyphosphate or red phosphorus, chloroparaffins, nitrogen-containing compounds, for example melamine, melamine cyanurate or melamine polyphosphate, or halogenated compounds, for example chlorinated and/or brominated polyether polyols and/or polyester polyols. It is also possible to use mixtures of different flame retardants.

Unless the opposite is apparent from this description, it is possible to combine any preferred or particularly preferred embodiment of the invention with one or more of the other preferred or particularly preferred embodiments of the invention.

The process according to the invention for producing PU foams can be conducted by any known methods, for example by manual mixing or preferably by means of foaming machines. If the process is conducted using foaming machines, it is possible to use high-pressure or low-pressure machines. The process according to the invention can be carried out either batchwise or continuously and it is possible for example to use 1K, 1.5K or 2K systems as described in EP3717538 A1, U.S. Pat. No. 7,776,934 B2, EP1400547 B1 or EP2780384 B2.

One-component canned PU foam is well known to the person skilled in the art from the prior art. The term “one-component canned PU foam” in the context of the entire present invention encompasses polyurethane foams that are preferably characterized by the presence of a polyol-isocyanate prepolymer that can be blown from a pressurized can by propellant gases and hence foamed.

Suitable polymers that are preferred for this purpose are obtainable, for example, by reacting polyols and isocyanates with one another by means of suitable catalysts (for example blowing catalysts such as 2,2′-dimorpholinyldiethyl ether) or else without catalyst action. The final curing of these prepolymers is then effected under the action of moisture, for example from the environment.

Spray foam is a free-risen foam which is applied to a substrate by spraying of the liquid reaction components onto a substrate. Processing is generally effected by a spray foam machine, which may be implemented as a high-or low-pressure machine and combines and mixes the two components (polyol mixture and isocyanate). The foam is typically discharged by means of a static mixer in the form of a spray gun. In principle, the raw materials or foam may alternatively be discharged by gas pressure from a larger vessel, similarly to the principle of canned foams. The foam serves for insulation purposes and for structural purposes in walls, roofs, floors, and may be open-cell or closed-cell depending on the application.

Packaging foam serves for packaging, protection and cushioning of sensitive goods. It is usual to use a low-density open-cell foam that is intended to tightly enclose the goods to be protected and protect them from damage, impacts etc. For this purpose, the foam is optionally also foamed directly into the interspace between packaging and goods.

Thermoformable rigid polyurethane foams are rigid polyurethane foams that are mechanically deformed after production, for example by the application of heat, water/steam and pressure. The foam, which is in block form at first and is optionally cut to size, is used to produce a shaped article. Examples are headliner foam and hoodliner foam (foam for tailgates and cladding). Floral foam, which is used, for example, for the arrangement of flowers etc., is a polyurethane foam which, by virtue of a low density, mechanical properties and high open-cell content, is suitable for accommodating flowers and further objects by insertion into the foam.

Pipe insulation foam is a polyurethane foam which is used for insulation of pipes. It first protects the pipe or pipe contents from losses of heat or refrigeration, and secondly from mechanical influences. Especially in the field of pipes laid in water bodies, at sea and in the deep ocean, a high open-cell content is desirable in some cases for mechanical reasons.

In principle, however, the cell openers described in this invention are also usable in all other PU foam, especially rigid PU foam applications, in which a high open-cell content is desired, which, for example, has a direct positive effect on the dimensional stability of the foam.

The measurement of the open-cell content/closed-cell content of a rigid polyurethane foam may preferably take place according to DIN ISO 4590:2016-12, “Rigid cellular plastics—Determination of the volume percentage of open cells and of closed cells”, for example with a gas pycnometer.

A high open-cell content in the context of this invention is considered to be an open-cell content of more than 50% of the cells.

The dimensional stability of a one-component canned PU foam can preferably be measured by method TM 1004:2013 of the FEICA—Association of the European Adhesive & Sealant Industry.

The preparation of the polyether-siloxane block copolymers according to the invention is based on the hydrosilylation reaction which is known to the person skilled in the art, and can be effected by such a reaction of alpha, omega-modified hydrosiloxanes with alpha, omega-modified di(meth)allyl polyethers. The chemical reactions forming the basis of this preparation are known in the technical literature and are described extensively therein (see, for example, Silicones—Chemistry and Technology, Vulkan-Verlag Essen, 1989).

The invention is described further and by way of example hereinafter, without any intention that the invention be restricted to these illustrative embodiments. Where ranges, formulae, or classes of compound are stated below, these are intended to encompass not only the corresponding ranges or groups of compounds mentioned explicitly, but also all subranges and subgroups of compounds that can be obtained by extracting individual values (ranges) or compounds. Where documents are cited in the context of the present description, the entire content thereof, particularly with regard to the subject matter that forms the context in which the document has been cited, is intended to form part of the disclosure content of the present invention. Unless stated otherwise, percentages are in weight per cent. Molar percentages are identified in abbreviated form by m %. Where parameters which have been determined by measurement are reported below, the measurements have been carried out at a temperature of 25°° C. and a pressure of 101 325 Pa (standard pressure), unless stated otherwise. Where chemical (empirical) formulae are used in the present invention, the specified indices can be not only absolute numbers but also average values. For polymeric compounds, the indices preferably represent average values. Structural and empirical formulae presented in the present invention are representative of all isomers that are possible by differing arrangement of the repeating units. Where, in the context of the present invention, compounds such as polyethers, siloxanes or polyether siloxanes, for example, that can have different units multiple times are described, these can occur in statistical distribution (statistical oligomer or polymer), in ordered form (block oligomer or block polymer) or as gradient distribution in these compounds.

The solvent mixture according to the invention which is used in the process according to the invention comprises not only aromatic solvent of the formula 5 but also alkoxylated alcohol of the formula 6. In a preferred embodiment of the present invention, the aromatic solvent of the formula 5 and the alkoxylated alcohol of the formula 6 are used in a mass ratio of 1:2 to 15:1, preferably in a mass ratio of 3:2 to 12:1.

The reactants used are alpha,omega-modified hydrosiloxanes and alpha, omega-modified di(meth)allyl polyethers, and are used in the presence of a hydrosilylation catalyst.

When the sum total of the masses of aromatic solvents of the formula 5 and of the alkoxylated alcohol of the formula 6 and the sum total of the masses of the reactants are in a ratio of 7:3 to 1:4, this is a further preferred embodiment of the invention.

The alpha, omega-modified di(meth)allyl polyether is preferably used in such a concentration that the molar ratio of polyether-bound double bonds to Si-H groups is in the range from 0.95:1.05 to 1.05:0.95, preferably in the range from 0.97:1.03 to 1.03:0.97, more preferably in the range from 0.99:1.01 to 1.01:0.99. This too is a preferred embodiment of the invention.

The hydrosilylation according to the invention is effected in the presence of a hydrosilylation catalyst When the hydrosilylation catalyst used for the reaction is selected from the group of the platinum catalysts, especially the platinum(0) catalysts, with very particular preference especially for platinum(0) catalyst in the form of the Karstedt catalyst, this is a further preferred embodiment of the invention.

Such catalysts are known; see, for example, Lewis et al., “Platinum Catalysts used in Silicones Industry”, Platinum Metal Review, 1997, 44(23), 66-74.

The polyethersiloxanes prepared by the process according to the invention preferably have a weight-average molar mass Mw of at least 60 000 g/mol, preferably of at least 80 000 g/mol, more preferably of at least 90 000 g/mol, and a number average molar mass Mn of at least 25 000, preferably of at least 27 500 g/mol, more preferably of at least 30 000 g/mol. It is further preferable when the ratio of Mw/Mn is less than 4.5, preferably less than 4.0, more preferably less than 3.5. The terms “weight-average molar mass Mw” and “number-average molar mass Mn” are known to the person skilled in the art. These two parameters can preferably be determined by gel permeation chromatography (GPC), preferably calibrated against polystyrene. For this purpose, for example, it is possible to use the SECcurity2 GPC system from PCC, calibrated against polystyrene. In particular, it is possible to use the PCC SECcurity 1260 GPC system, preferably with the following experimental framework parameters: SDV 1000/10000 Å column combination, PSS SECurity 1260 RI detector, mobile phase: THF, flow rate: 1 ml/min), calibrated against polystyrene (162-2 520 000 g/mol).

The mixtures obtained from the process of the invention can be used in accordance with the invention for production of polyurethane foams, especially rigid polyurethane foams.

The present invention thus further provides a formulation suitable as additive for the production of polyurethane foams, preferably rigid polyurethane foam, comprising the following components:

(a) polyether-siloxane block copolymers of formula 1

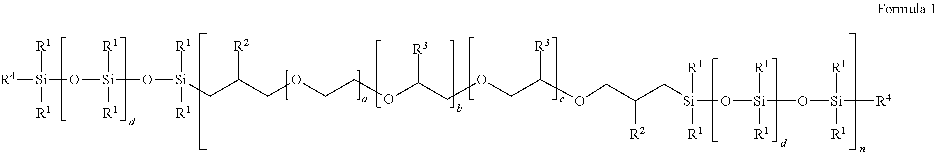

where
a=0 to 100, preferably 5 to 75, more preferably 10 to 50,
b=0 to 100, preferably 5 to 75, more preferably 5 to 25,
c=0 to 100, preferably 5 to 75, more preferably 5 to 25,
d=1 to 100, preferably 5 to 50, more preferably 7 to 40, most preferably 12-30,
n=5-200, preferably 10-100, more preferably 15-50, and
where the R¹ radicals are independently identical or different monovalent aliphatic or aromatic hydrocarbon radicals having 1 to 20 carbon atoms, preferably having 1 to 10 carbon atoms, most preferably methyl radicals,
and where the R² radicals are independently identical or different monovalent aliphatic, saturated or unsaturated hydrocarbon radicals having 1 to 20 carbon atoms or OH, preference being given especially to methyl radicals,
and where the R³ radicals are independently identical or different monovalent aliphatic or aromatic hydrocarbon radicals having 1 to 20 carbon atoms, preferably methyl radicals,
and where the R⁴ radicals are independently selected from one of the R⁵, R⁶, R⁷ radicals and H, where the R⁵ radicals conform to the formula 2

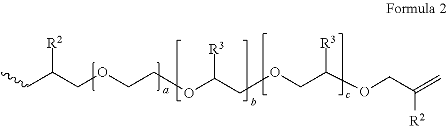

and where the R⁶ radicals conform to the formula 3

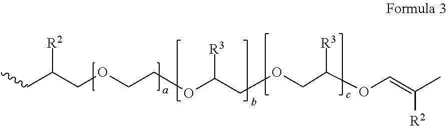

and where the R⁷ radicals conform to the formula 4

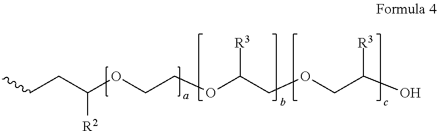

where the indices a, b and c and the R² and R³ radicals are as defined above,
(b) at least one aromatic solvent of the general formula 5

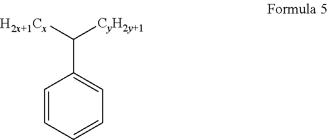

where
x=0-20, preferably 0-16,
y=0-20, preferably 0-16,
x+y=6-20, preferably 8-16,
and
(c) at least one alkoxylated alcohol of the formula 6

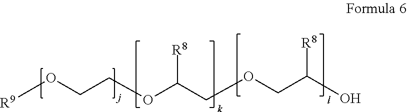

where
j=0 to 30, preferably 0 to 10, more preferably 0 to 5,
k=1 to 20, preferably 2 to 10, more preferably 3 to 5,
l=1 to 20, preferably 2 to 10, more preferably 3 to 5, and
where the R⁹ radical is a monovalent aliphatic saturated or unsaturated, linear or branched hydrocarbon radical having 6-40, preferably having 8-30, even more preferably having 10-22, carbon atoms, and where the R⁸ radicals are independently identical or different monovalent aliphatic or aromatic hydrocarbon radicals having 1 to 20 carbon atoms, preferably methyl radicals.

In a preferred embodiment of the invention, components b) and c) are present in the formulation in a mass ratio of 1:2 to 15:1, preferably in a mass ratio of 3:2 to 12:1.

In addition, preference is given to formulations in which the ratio of the sum total of the masses of (b) and (c) to (a) is 8:2 to 1:4. This corresponds to a preferred embodiment of the invention.

In addition, preference is given to formulations in which the polyether-siloxane block copolymer of the formula 1 is present in a concentration of at least 20% by weight, preferably of at least 25% by weight, more preferably of at least 30% by weight, based on the overall formulation.

In a very particularly preferred embodiment of the invention, the formulation according to the invention does not contain any polyether of the formula 8

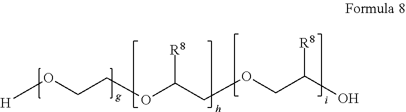

where
g=0 to 75, preferably 0 to 50, more preferably 0 to 2,
h=1 to 100, preferably 2 to 50, more preferably 3 to 25,
i=1 to 100, preferably 2 to 50, more preferably 3 to 25, and
where the R⁸ radicals are independently identical or different monovalent aliphatic or aromatic hydrocarbon radicals having 1 to 20 carbon atoms, preferably methyl radicals.

The present invention enables, as already stated, the provision of polyether-siloxane block copolymers having high molecular weights coupled with narrow molar mass distribution.

A formulation according to the invention comprising polyether-siloxane block copolymers of formula 1 having an M_{w} (g/mol) of ≥60 000, preferably >80 000, especially >90 000, where M_{w}/Mₙ<4.5, preferably <4.0, especially <3.5, is a particularly preferred embodiment of the invention. As already described further up, M_{w} and Mₙ in the context of this invention can preferably be determined by gel permeation chromatography (GPC), preferably calibrated against polystyrene.

In addition, it may be preferable when the formulation according to the invention also comprises a pendent stabilizer as an additional component. Pendent stabilizers here are likewise polyethersiloxanes, but one that have a silicone chain bearing pendent and/or terminal polyether chains. The polyether chains here may be bonded to the silicone chain either via a silicon-carbon bond (Si-C) or a silicon-oxygen-carbon bond (Si-O-C), particular preference being given to silicon-carbon bonds. Preference is given here especially to those pendent Si-C-based polyethersiloxanes that conform to the formula 7

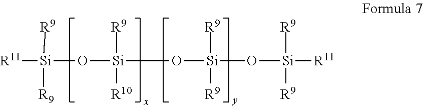

where
x=0 to 50, preferably 1 to 25, more preferably 2 to 15,
y=0 to 250, preferably 5 to 150, more preferably 5 to 100,
where the R⁹ radicals are independently identical or different monovalent aliphatic or aromatic hydrocarbon radicals having 1 to 20 carbon atoms, preferably having 1 to 10 carbon atoms, and are most preferably methyl radicals, and where the R¹⁰ radicals are independently identical or different OH-functional or-terminated, preferably methyl-or acetyl-terminated, polyoxyalkylene radicals, preferably polyoxyethylenepolyoxypropylene radicals, and where the R¹¹ radicals correspond either to R⁹ or R¹⁰.

Since, as described above, the polyether-siloxane block copolymers according to the invention are efficient cell openers for the production of polyurethane foams, especially open-cell rigid polyurethane foams, the present invention likewise provides for the use of the formulations according to the invention as additives, especially as cell-opening additive or cell opener, in the production of polyurethane foams, preferably rigid polyurethane foams and especially one-component canned PU foams, especially in combination with pendent stabilizer of formula 7.

This invention thus also further provides a polyurethane foam, preferably rigid polyurethane foam, produced using a formulation according to the invention as described above.

The invention further provides for the use of a polyurethane foam of the invention, preferably a rigid polyurethane foam, as described above, for production of foam mouldings, spray foam, insulation foam, sealing compounds, adhesive compounds, insulating compounds, assembly compounds and/or filler compounds.

As already described above, the polyethersiloxanes obtainable by the process according to the invention are notable for a particularly advantageous molar mass and for a particularly advantageous molar mass distribution, which means that they are particularly suitable for use as additive for the production of polyurethane foams, preferably rigid polyurethane foams. The present invention therefore further provides polyether-siloxane block copolymers conforming to the formula 1

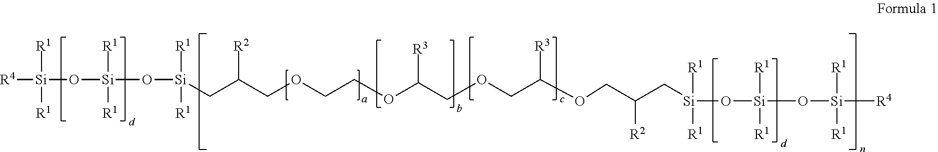

where
a=0 to 100, preferably 5 to 75, more preferably 10 to 50,
b=0 to 100, preferably 5 to 75, more preferably 5 to 25,
c=0 to 100, preferably 5 to 75, more preferably 5 to 25, a+b+c>3,
d=1 to 100, preferably 5 to 50, more preferably 7 to 40, most preferably 12-30,
n=5-200, preferably 10-100, more preferably 15-50, and
where the R¹ radicals are independently identical or different monovalent aliphatic or aromatic hydrocarbon radicals having 1 to 20 carbon atoms, preferably having 1 to 10 carbon atoms, most preferably methyl radicals,
and where the R² radicals are independently identical or different monovalent aliphatic, saturated or unsaturated hydrocarbon radicals having 1 to 20 carbon atoms or OH, preference being given especially to methyl radicals,
and where the R³ radicals are independently identical or different monovalent aliphatic or aromatic hydrocarbon radicals having 1 to 20 carbon atoms, preferably methyl radicals,
and where the R⁴ radicals are independently selected from one of the R⁵, R⁶, R⁷ radicals and H, where the R⁵ radicals conform to the formula 2

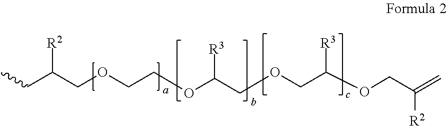

and where the R⁶ radicals conform to the formula 3

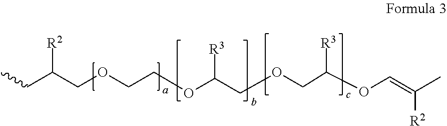

and where the R⁷ radicals conform to the formula 4

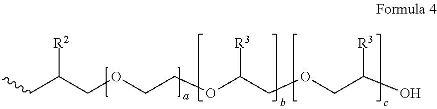

where the indices a, b and c and the R² and R³ radicals are as defined above, and having a weight-average molar mass Mw of at least 60 000 g/mol, preferably of at least 80 000 g/mol, more preferably of at least 90 000 g/mol, and a number-average molar mass Mn of at least 25 000 g/mol, preferably of at least 27 500 g/mol, more preferably of at least 30 000 g/mol, it being especially preferable when the ratio of Mw/Mn is less than 4.5, preferably less than 4.0, more preferably less than 3.5. These polyether-siloxane block copolymers can preferably be prepared by the process according to the invention as described in detail above.

In particular, it is preferable when these polyether-siloxane block copolymers are prepared without the use of polyethers of the formula 8

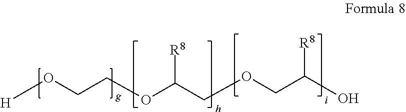

where
g=0 to 75, preferably 0 to 50, more preferably 0 to 2,
h=1 to 100, preferably 2 to 50, more preferably 3 to 25,
i=1 to 100, preferably 2 to 50, more preferably 3 to 25, and
where the R⁸ radicals are independently identical or different monovalent aliphatic or aromatic hydrocarbon radicals having 1 to 20 carbon atoms, preferably methyl radicals.

The present invention still further provides for the use of these polyether-siloxane block copolymers according to the invention as additives for the production of polyurethane foams, preferably rigid polyurethane foams, especially in combination with at least one additional polyethersiloxane-based stabilizer having a siloxane chain bearing pendent and/or terminal polyether chains, where the polyether chains may be bonded to the silicone chain via either a silicon-carbon bond (Si—C) or a silicon-oxygen-carbon bond (Si—O—C), particular preference being given to silicon-carbon bonds, and preference being given especially to those pendent Si—C-based polyethersiloxanes that conform to the formula 7, as already defined above,
in which context reference is made in full to the preceding description.

### EXAMPLES

The examples which follow serve solely for elucidation of this invention to the person skilled in the art and do not constitute any kind of restriction of the subject-matter claimed.

### Materials

a) SiH siloxane A

In the syntheses that follow, a siloxane of the general formula a was used.

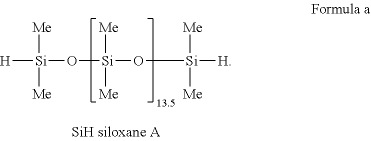

b) Bismethallyl polyether A

In the syntheses that follow, a bismethallyl polyether of the general formula b was used.

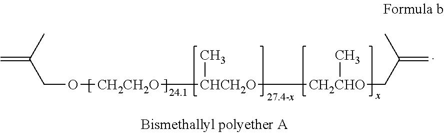

### Synthesis examples

### Example 1: Synthesis in Toluene (Comparative Example)

A 500 ml three-neck flask with precision glass stirrer and reflux condenser was initially charged with 73 g of bismethallyl polyether A. Subsequently, 103 g of toluene and 30 g of SiH siloxane A were added. The reaction mixture was heated to 80° C. Thereafter, 10 ppm of Pt was added in the form of the Karstedt catalyst solution. The reaction mixture was heated to 95° C. and stirred at that temperature for 3 hours. The result was a gel-like product that was intermediately diluted with a further 103 g of toluene in order to keep it stirrable. A clear gel-like product was obtained. Because viscosity was very high, it was not possible to remove the solvent by distillation.

### Example 2: Synthesis in toluene/alkoxylated Alcohol (Comparative Example)

A 1000 ml three-neck flask with precision glass stirrer and reflux condenser was initially charged with 73 g of bismethallyl polyether A. Subsequently, 103 g of toluene, 103 g of Varonic® APM T (myristyl alcohol propoxylate) and 30 g of the SiH siloxane A were added. The reaction mixture was heated to 80° C. Thereafter, 10 ppm of Pt was added in the form of the Karstedt catalyst solution. The reaction mixture was heated to 95° C. and stirred at that temperature for 3 hours. The volatile constituents were then removed under reduced pressure at 130° C. and 1 mbar. A cloudy product was obtained.

### Example 3: Synthesis in dodecylbenzene/alkoxylated Alcohol

A 1000 ml three-neck flask with precision glass stirrer and reflux condenser was initially charged with 73 g of bismethallyl polyether A. Subsequently, 103 g of dodecylbenzene (CAS number: 123-01-3), 103 g of Varonic® APM T (myristyl alcohol propoxylate) and 30 g of the SiH siloxane A. The reaction mixture was heated to 80° C. Thereafter, 10 ppm of Pt was added in the form of the Karstedt catalyst solution. The reaction mixture was heated to 95° C. and stirred at that temperature for 3 hours. The volatile constituents were then removed under reduced pressure at 130° C. and 1 mbar. A clear product of high viscosity was obtained.

TABLE 1
Overview of experiments

| | w (SiH siloxane + | | | | | |
|---|---|---|---|---|---|---|
| | bismethallyl | | w (aromatic | W (Varonic ® | | |
| Ex. | polyether) | Aromatic solvent | solvent) | APM T) | Mw / (g/mol) | Appearance |
| 1 | 50% | toluene | 50% | 0% | 164254 | gel-like |
| 2 | 33.34% | toluene | 33.33% | 33.33% | 96000 | cloudy |
| 3 | 33.34% | dodecylbenzene | 33.33% | 33.33% | 115807 | clear |

Comparison of examples 2 and 3 shows that the use of dodecylbenzene in conjunction with an alkoxylated alcohol enables the production of clear products. Moreover, dodecylbenzene is not an inflammable solvent. Because of these two points, the product has better suitability as foam stabilizer.

1-15. (canceled)

16. A process for preparing polyether-siloxane block copolymers of formula 1: 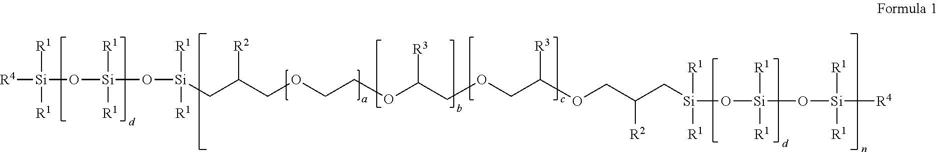
wherein:
a=0 to 100,
b=0 to 100,
c=0 to 100,
and a+b+c>3,
d=1 to 100,
n=5 to 200,
wherein R¹ radicals are independently identical or different monovalent aliphatic or aromatic hydrocarbon radicals having 1 to 20 carbon atoms,
wherein R² radicals are independently identical or different monovalent aliphatic, saturated or unsaturated hydrocarbon radicals having 1 to 20 carbon atoms or OH,
wherein R³ radicals are independently identical or different monovalent aliphatic or aromatic hydrocarbon radicals having 1 to 20 carbon atoms,
wherein R⁴ radicals are independently selected from one of R⁵, R⁶, R⁷ radicals and H,
wherein R⁵ radicals conform to formula 2: 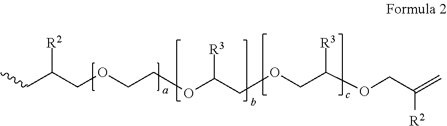
wherein R⁶ radicals conform to formula 3: 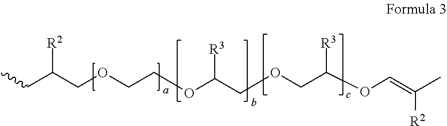
and where R⁷ radicals conform to the formula 4: 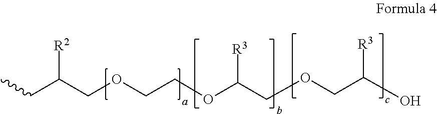
wherein the indices a, b and c and R² and R³ radicals are as defined above, by hydrosilylation of alpha,omega-modified hydrosiloxanes with alpha,omega-modified di(meth)allyl polyethers in the presence of a hydrosilylation catalyst capable of catalysing the formation of an SiC bond by addition of an Si—H group to a (meth)allylic double bond, wherein the reaction is conducted in a solvent mixture comprising at least one aromatic solvent of formula 5: 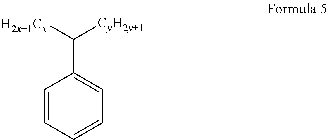
wherein:
x=0-20,
y=0-20,
x+y=6-20,
and at least one alkoxylated alcohol of formula 6: 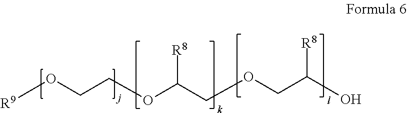
wherein:
j=0 to 30,
k=0 to 20,
l=1 to 20,
wherein the R⁹ radical is a monovalent aliphatic saturated or unsaturated, linear or branched hydrocarbon radical having 6-40 carbon atoms, and
wherein R⁸ radicals are independently identical or different monovalent aliphatic or aromatic hydrocarbon radicals having 1 to 20 carbon atoms.

17. The process of claim 16, wherein:
in formula 1:
a=5 to 75,
b=5 to 75,
c=5 to 75,
d=5 to 50,
n=10 to 100, and
wherein the R¹ radicals are methyl radicals,
wherein the R² radicals are methyl radicals,
in formula 5:
x=0-16,
y=0-16,
x+y=8-16,
in formula 6:
j=0 to 10,
k=0 to 10,
l=2 to 10, and
wherein the R⁹ radical is a monovalent aliphatic saturated or unsaturated, linear or branched hydrocarbon radical having 10-22, carbon atoms.

18. The process of claim 16, wherein:
in formula 1:
a=10 to 50,
b=5 to 25,
c=5 to 25,
d=7 to 40, and
n=15 to 50.

19. The process of claim 16, wherein:
in formula 1:
d=12 to 30, and
n=15 to 50.

20. The process of claim 16, wherein:
in formula 6:
j=0 to 10,
k=0 to 10,
l=2 to 10.

21. The process of claim 16, wherein the aromatic solvent of formula 5 and the alkoxylated alcohol of formula 6 are used in a mass ratio of 1:2 to 15:1.

22. The process of claim 16, wherein the aromatic solvent of formula 5 and the alkoxylated alcohol of formula 6 are used in a mass ratio of 3:2 to 12:1.

23. The process of claim 16, wherein the sum total of the masses of aromatic solvent of formula 5 and of the alkoxylated alcohol of formula 6 is in a ratio of 8:2 to 1:4 to the sum total of the masses of the reactants.

24. The process of claim 16, wherein the alpha,omega-modified di(meth)allyl polyether is used at a concentration such that the molar ratio of polyether-bound double bonds to siloxane-bound Si—H groups is in the range from 0.95:1.05 to 1.05:0.95.

25. The process of claim 16, wherein the hydrosilylation catalyst used for the reaction is a platinum catalyst.

26. A formulation suitable as an additive for the production of polyurethane foams, comprising the following components:
(a) polyether-siloxane block copolymers of formula 1: 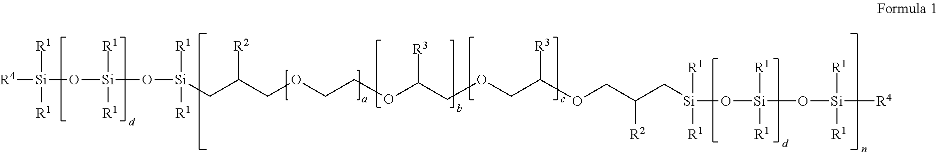
wherein:
a=0 to 100,
b=0 to 100,
c=0 to 100,
d=1 to 100,
n=5-200,
wherein R¹ radicals are each independently identical or different monovalent aliphatic or aromatic hydrocarbon radicals having 1 to 20 carbon atoms,
wherein R² radicals are independently identical or different monovalent aliphatic, saturated or unsaturated hydrocarbon radicals having 1 to 20 carbon atoms or OH,
wherein R³ radicals are independently identical or different monovalent aliphatic or aromatic hydrocarbon radicals having 1 to 20 carbon atoms,
wherein R⁴ radicals are independently selected from R⁵, R⁶, R⁷ radicals and H, where R⁵ radicals conform to formula 2: 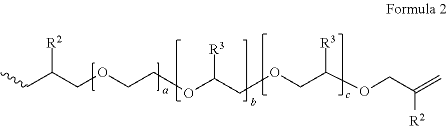
wherein R⁶ radicals conform to formula 3: 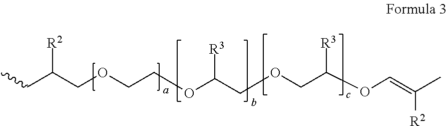
wherein R⁷ radicals conform to formula 4: 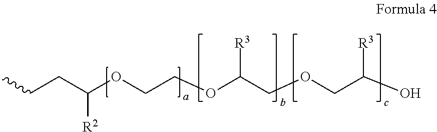
wherein the indices a, b and c and the R² and R³ radicals are as defined above, (b) an aromatic solvent of formula 5: 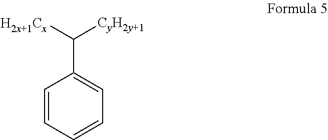
wherein:
x=0-20,
y=0-20,
x+y=6-20,
and
(c) an alkoxylated alcohol of the formula 6: 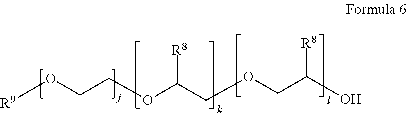
wherein:
j=0 to 30,
k=1 to 20,
l=1 to 20, and
wherein the R⁹ radical is a monovalent aliphatic saturated or unsaturated, linear or branched hydrocarbon radical having 6-40, carbon atoms, and
wherein R⁸ radicals are independently identical or different monovalent aliphatic or aromatic hydrocarbon radicals having 1 to 20 carbon atoms.

27. The formulation of claim 26, wherein in formula 1:
a=0 to 100,
b=0 to 100,
c=0 to 100,
d=1 to 100,
n=5-200, and
wherein the R¹ radicals are each independently identical or different monovalent aliphatic or aromatic hydrocarbon radicals having 1 to 10 carbon atoms;
wherein the R² radicals are independently identical or different monovalent aliphatic, saturated or unsaturated hydrocarbon radicals having 1 to 20 carbon atoms OH; and
wherein the R³ radicals are independently identical or different monovalent aliphatic or aromatic hydrocarbon radicals having 1 to 20 carbon atoms.

28. The formulation of claim 27, wherein R² and R³ are methyl radicals.

29. The formulation of claim 26, wherein, in formula 5:
x=0-16;
y=0-16; and
x+y=8-16.

30. The formulation of claim 26, wherein, in formula 6:
j=0 to 10,
k=2 to 10,
l=2 to 10,
wherein the R⁹ radical is a monovalent aliphatic saturated or unsaturated, linear or branched hydrocarbon radical having 10-22, carbon atoms, and
wherein the R⁸ radicals are methyl radicals.

31. The formulation of claim 26, wherein the ratio of the sum total of the masses of (b) and (c) to (a) is 8:2 to 1:4.

32. The formulation of claim 26, wherein the polyether-siloxane block copolymer of formula 1 has a M_{w} (g/mol) of ≥60 000, where M_{w}/Mₙ<4.5.

33. The formulation of claim 26, further comprising at least one pendent polyethersiloxane-based stabilizer having a siloxane chain bearing pendent and/or terminal polyether chains, where the polyether chains may be bonded to the silicone chain via either a silicon-carbon bond (Si—C) or a silicon-oxygen-carbon bond (Si—O—C).

34. The formulation of claim 33, wherein polyether chains are bonded to the silicone by a Si—C-based polyethersiloxanes that conform to formula 7: 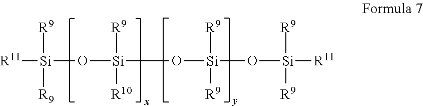
wherein:
x=0 to 50,
y=0 to 250, and
where R⁹ radicals are independently identical or different monovalent aliphatic or aromatic hydrocarbon radicals having 1 to 20 carbon atoms, and wherein R¹⁰ radicals are independently identical or different OH-functional or-terminated, and wherein R¹¹ radicals correspond either to R⁹ or R¹⁰.

35. A polyether-siloxane block copolymer, prepared by the process of claim 16.
